(19) United States
(12) Patent Application Publication
(10) Pub. No.: US 2025/0113277 A1
(43) Pub. Date: Apr. 3, 2025

(54) SYSTEMS AND METHODS FOR TIME-BASED HANDOVER IN NON-TERRESTRIAL NETWORKS

(71) Applicant: TELEFONAKTIEBOLAGET LM ERICSSON (PUBL), Stockholm (SE)

(72) Inventors: Claes-Göran Persson, MJÖLBY (SE); Johan Rune, LIDINGÖ (SE); Gino Luca Masini, STOCKHOLM (SE)

(21) Appl. No.: 18/725,333

(22) PCT Filed: Jan. 13, 2023
(86) PCT No.: PCT/IB2023/050335

§ 371 Date: Jun. 28, 2024

Related U.S. Application Data
(60) Provisional application No. 63/299,580, filed on Jan. 14, 2022.

(51) Int. Cl. H04W 36/24; H04W 36/00; H04W 36/36; H04W 84/06

(52) U.S. Cl. CPC H04W 36/249; H04W 36/0016; H04W 36/362; H04W 84/06

(57) ABSTRACT

A method (700) by a source network node (110A) for handover of a wireless device (112) in a Non-Terrestrial Network (NTN) to a target network node (110B) includes transmitting (702), to the target network node, time information for performing, by the wireless device, the handover to a target cell associated with the target network node.

### TECHNICAL FIELD

The present disclosure relates, in general, to wireless communications and, more particularly, systems and methods for time-based handover in Non-Terrestrial Networks (NTNs).

### BACKGROUND

In Third Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since Release 13 Narrowband-Internet of Things (NB-IoT) and LTE-Machine Type Communication (LTE-M) are part of the LTE specifications and provide connectivity to massive machine type communications (mMTC) services.

In 3GPP Release 15, the first release of the 5th Generation System (5GS) was specified. This is a new generation radio access technology intended to serve use cases such as Enhanced Mobile Broadband (eMBB), Ultra-Reliable and Low Latency Communication (URLLC) and mMTC services. 5^{th} Generation (5G) includes the New Radio (NR) access stratum interface and the 5G Core Network (5GC). The NR physical and higher layers are reusing parts of the LTE specification, and additional components are introduced when motivated by the new use cases.

In Release 15, 3GPP also started the work to prepare NR for operation in a Non-Terrestrial Network (NTN). The work was performed within the Study Item “NR to support Non-Terrestrial Networks” and resulted in 3GPP TR 38.811. In Release 16, the work to prepare NR for operation in a NTN continued with the Study Item “Solutions for NR to support Non-Terrestrial Network.” The Release 16 study item resulted in a Work Item being agreed for NR in Release 17, “Solutions for NR to support non-terrestrial networks (NTN).”

### Satellite Communications

A satellite radio access network usually includes the following components:
A satellite that refers to a space-borne platform.
An earth-based gateway that connects the satellite to a base station or a core network, depending on the choice of architecture.
Feeder link that refers to the link between a gateway and a satellite
Access link (or Service link) that refers to the link between a satellite and a User Equipment (UE).

Depending on the orbit altitude, a satellite may be categorized as low earth orbit (LEO), medium earth orbit (MEO), or geostationary earth orbit (GEO) satellite.
LEO: typical heights ranging from 250-1,500 km, with orbital periods ranging from 90-120 minutes.
MEO: typical heights ranging from 1,500-35,786 km, with orbital periods ranging from 3-15 hours. MEO and LEO are also known as Non-Geo Synchronous Orbit (NGSO) type of satellite.
GEO: height at about 35,786 km, with an orbital period of 24 hours. Also known as a Geo Synchronous Orbit (GSO) type of satellite.

The significant orbit height means that satellite systems are characterized by a pathloss that is significantly higher than what is expected in terrestrial networks. To overcome pathloss, it is often required that the access and feeder links are operated in line of sight conditions and that the UE is equipped with an antenna offering high beam directivity.

A communication satellite typically generates several beams over a given area. The footprint of a beam is usually in an elliptic shape, which has been traditionally considered as a cell. The footprint of a beam is also often referred to as a spotbeam. The spotbeam may move over the earth surface with the satellite movement or may be earth fixed with some beam pointing mechanism used by the satellite to compensate for its motion. The size of a spotbeam depends on the system design, which may range from tens of kilometers to a few thousands of kilometers. FIG. 1 illustrates an example architecture of a satellite network with bent pipe transponders. This is also known as a transparent payload architecture.

The NTN beam may in comparison to the beams observed in a terrestrial network be very wide and cover an area outside of the area defined by the served cell. Beam covering adjacent cells will overlap and cause significant levels of intercell interference. To overcome the large levels of interference a typical approach in NTN is to configure different cells with different carrier frequencies and polarization modes.

Three types of service links are supported in NTN:
Earth-fixed: provisioned by beam(s) continuously covering the same geographical areas all the time (e.g., in the case of GEO satellites).
Quasi-earth-fixed: provisioned by beam(s) covering one geographic area for a limited period and a different geographic area during another period (e.g., in the case of NGSO satellites generating steerable beams).
Earth-moving: provisioned by beam(s) whose coverage area slides over the earth surface (e.g., in the case of NGSO satellites generating fixed or non-steerable beams).

### Connected State Mobility

In connected state, which is referred to in the 3GPP specifications as the RRC_CONNECTED state, the UE has an active connection to the network for sending and receiving of data and signaling. In the connected state, mobility is controlled by the network to ensure connectivity is retained to the UE with no interruption or noticeable degradation of the provided service as the UE moves between the cells within the network. As requested by the network, the UE is required to search and perform measurements on neighbor cells both on the current carrier frequency (intra-frequency) as well as on other carrier frequencies (inter-frequency). The UE does not take any autonomous decisions when to trigger a handover to a neighbor cell (except to some extent when the UE is configured for Conditional Handover as discussed in more detail below). Instead, the UE sends the measurement results from the serving and neighboring cells to the network where a decision is taken whether or not to perform a handover to one of the neighbor cells.

Connected state mobility is also known as handover. During the handover, the UE is moved from a source node using a source cell connection to a target node using a target cell connection. The target cell connection is associated with a target cell controlled by a target node. In other words, during a handover, the UE moves from the source cell to a target cell. The source node may also be referred to as a source access node, a source radio network node, or a source network node. Likewise, the target node may also be referred to as a target access node, a target radio network node, or a target network node. In the 5G system, the source network node and the target network node are referred to as the source gNB and the target gNB, respectively.

In some cases, the source network node and the target network node are different nodes, such as different gNBs. These cases are also referred to as inter-node or inter-gNB handover.

In other cases, the source network node and the target network node are the same node such as, for example, the same gNB. These cases are referred to as intra-node or intra-gNB handover and also covers the case when the source and target cells are controlled by the same node.

In yet another case, handover is performed within the same cell and, thus, also within the same node controlling that cell. These cases are referred to as intra-cell handover.

It should also be understood that the source network node and the target network node refer to a role served by a given access node during a handover of a specific UE. For example, a given access node may serve as source network node during handover of one UE, while it also serves as the target network node during handover of a different UE. And, in case of an intra-node or intra-cell handover of a given UE, the same access node serves both as the source network node and target network node for that UE.

An inter-node handover can further be classified as an Xn-based or NG-based handover depending on whether the source network node and target network node communicate directly using the Xn interface or indirectly via the Core Network (CN) using the NG interface.

FIG. 2 illustrates a simplified signaling flow between the UE, the source gNB and the target gNB during an Xn-based inter-gNB handover in NR.

Note that control plane data (i.e. Radio Resource Control (RRC) messages such as the measurement report, handover command, and handover complete messages) are transmitted on Signaling Radio Bearers (SRBs) while the user plane data is transmitted on Data Radio Bearers (DRBs).

As depicted, the signaling may include one or more of the following:
301-302. The UE has an active connection to the source gNB over which user data is sent and received to/from the network. Due to some trigger in the source gNB such as, for example, a measurement report received from the UE, the source gNB decides to handover the UE to a target (neighbor) cell controlled by the target gNB.
303. The source gNB sends the XnAP HANDOVER REQUEST message to the target gNB passing a transparent RRC container with necessary information to prepare the handover at the target side. The information includes, for example, the target cell identifier (ID), the target security key, the current source configuration and UE capabilities.
304. The target gNB prepares the handover and responds with a XnAP HANDOVER REQUEST ACKNOWLEDGE message to the source gNB, which includes the handover command (a RRCReconfiguration message containing the reconfigurationWithSync field) to be sent to the UE. The handover command includes configuration information that the UE should apply once the UE connects to the target cell. For example, the handover command may include a random access configuration, a new C-RNTI assigned by the target node, security parameters, etc.
305. The source gNB triggers the handover by sending the handover command (received from the target gNB in the previous step) to the UE.
306. Upon reception of the handover command, the UE releases the connection to the old (source) cell, starts the handover supervision timer T304, and starts to synchronize to the new (target) cell.
307-309. The source gNB stops scheduling any further downlink (DL) user data to the UE and sends the XnAP SN STATUS TRANSFER message to the target gNB indicating the latest Packet Data Convergence Protocol (PDCP) Sequence Number (SN) transmitter and receiver status. The source gNB now also starts to forward DL user data received from the CN to the target gNB, which buffers this data.
310. Once the UE the has completed the random access procedure in the target cell, the UE stops the T304 timer and sends the handover complete message (a RRCReconfigurationComplete message) to the target gNB.
311. Upon receiving the handover complete message, the target gNB starts sending and receiving user data to and from the UE. The target gNB requests the CN to switch the DL user data path between the User Plane Function (UPF) and the source network node to the target network node. Note that communication to the CN is not shown in FIG. 2. Once the path switch is completed, the target gNB sends the XnAP UE CONTEXT RELEASE message to the source gNB to release all resources associated to the UE.

### Conditional Handover (CHO)

In 3GPP Release 16, a new handover concept called Conditional Handover (CHO) was introduced in purpose to improve mobility robustness. CHO is addressing reliability issues in the handover procedure if, for example, the measurement report sent from the UE or the handover command sent from the network to the UE is lost due to quality issues with the radio link between the UE and the source node. This is typically the case when the handover is performed close to the cell edge.

To deal with this issue, CHO enables the network to transmit the handover command to the UE at an earlier stage when the quality of the radio link is still good such as, for example, before the UE gets close to the cell edge. The network configures the UE with one or more candidate target cells and with a CHO specific execution condition for each target cell. The CHO execution conditions are then evaluated by the UE and, when fulfilled for one of the candidate target cells, the UE triggers a handover to that target cell.

The principle for CHO, as defined in 3GPP TS 38.300 Release 16, is described in FIGS. 3A-3B. Specifically, FIGS. 3A-3B illustrate an inter-gNB Conditional Handover in NR. The RRCReconfiguration message in step 6 is the Handover Command containing the CHO configuration(s). The method begins with the UE sending Measurement and Control Reports at step 1. Based on, for example, the Measurement Report received from the UE at step 1, the source gNB decides to configure the UE for CHO at step 2.

At step 3, the source gNB prepares one or potentially more candidate target gNBs by including a CHO indicator and the current UE configuration in the HANDOVER REQUEST message sent over Xn. Unlike a regular (non-CHO) handover, CHO enables the network to prepare the UE with more than one candidate target cell, each candidate target cell with its own target cell configuration (RRC Reconfiguration) and its own CHO execution condition. The target cell configuration is generated by the candidate target gNB while the CHO execution condition is configured by the source gNB. For CHO in Release 16, the CHO execution condition may consist of one or two trigger conditions such as the A3 and A5 signal strength/quality based events, as defined in 3GPP TS 38.331.

As in a regular (non-CHO) handover, the handover command (RRCReconfiguration message) sent to the UE in step 6 is generated by the candidate target gNB but transmitted to the UE in the source cell by the source gNB. In case of an inter-node handover, as in FIGS. 3A-3B, the handover command is sent from the candidate target gNB to the source gNB within the Xn HANDOVER REQUEST ACKNOWLEDGE message at step 5 as a transparent container, and the source gNB does not change the content of the handover command.

The target cell configuration (RRC Reconfiguration for the UE to use in the candidate target cell) and the CHO execution condition for each candidate target cell provided by the network to the UE is also known as the CHO configuration. When received by the UE in the handover command (RRCReconfiguration message in step 6), the target cell configuration is not applied immediately as in a regular (non-CHO) handover. Instead the UE starts to evaluate the CHO execution condition(s) configured by the network.

The network may configure the UE with one or two trigger conditions (A3 and/or A5 event) per CHO execution condition and candidate target cell. If the UE is configured with two trigger conditions, then both events need to be fulfilled in order to trigger the CHO to the candidate target cell.

When the CHO execution condition is fulfilled for one of the candidate target cells, the UE detaches from the source cell, applies the associated target cell configuration (RRC Reconfiguration), and starts the handover supervision timer T304. At step 8, the UE then connects to the target gNB as in a regular handover. Any CHO configuration stored in the UE after completion of the RRC handover procedure is now released.

At step 8a, the target gNB sends the HANDOVER SUCCESS message over Xn to the source gNB to inform that the UE has successfully accessed the target cell. Triggering of data forwarding to the target gNB is typically done after receiving the HANDOVER SUCCESS message in the source gNB. This is also known as “late data forwarding.” As an alternative, data forwarding may be triggered at an earlier stage in the handover procedure such as after receiving the RRCReconfigurationComplete message from the UE, at step 7. This mechanism is also known as “early data forwarding.”

If more than one candidate target cell is configured to the UE during the Handover Preparation phase, then the source gNB needs to cancel the CHO for the candidate target cells not selected by the UE. The source gNB sends the HANDOVER CANCEL message over Xn towards the other signalling connection(s) or other candidate target node(s) to cancel the CHO and to initiate a release of the reserved resources in the target gNB(s), at step 8c. During a regular (non-CHO) handover, if the handover attempt fails due to, for example, a radio link failure or an expiration of timer T304, the UE will typically perform a cell selection and continue with a re-establishment procedure. But when a CHO execution attempt fails and the selected cell is associated to a candidate target cell included in the CHO configuration, the UE will instead attempt a CHO execution to the selected target cell. This UE behaviour is, however, enabled/disabled by means of network configuration.

### CHO for NTN

Connected mode mobility challenges have been studied in the NTN Release 16 study item phase and are reported in 3GPP TR 38.821. Two of the challenges discussed in the Technical Report are frequent and unavoidable handovers such as, for example, due to feeder link switch and handover of a large number of UEs. Both could result in significant control plane overheads and frequent service interruptions. This issue is perhaps most pronounced in the quasi-earth-fixed cell scenario when a geographic area is covered by a satellite for a limited time period while being replaced by a new satellite during the next time period, and so on. When the satellite covering the geographic area is replaced, the cell is also replaced, meaning that all the UEs connected in the old cell have to be handed over to the new cell, which potentially results in a high control signaling peak because all of the handovers have to occur in conjunction with the cell replacement/switch. Hard and soft cell switch have been discussed. The preference is for the soft switch case in which the old and the new cell both (simultaneously) cover the geographic area during a short overlap period as this simplifies handovers and reduces interruptions.

To mitigate the expected signalling overhead at frequent handovers for a large number of UEs, 3GPP agreed to introduce support for Conditional Handover (CHO) for NTN in Release 17 with the CHO procedure and the trigger conditions as defined in Release 16 as a baseline.

In terrestrial networks, a UE can typically determine that the UE is near a cell edge due to a clear difference in received signal strength as compared to the cell center. The received signal strength may be determined by performing Reference Signal Received Power (RSRP) measurements. In NTN deployments, on the other hand, there is typically only a small difference in signal strength between the cell center and the cell edge. Thus, a UE may experience a small difference in signal strength between two beams (cells) in a region of overlap. This may lead to suboptimal UE behaviours such as repetitive handovers (“ping-pong”) between the two cells.

To avoid an overall reduction in handover robustness, 3GPP agreed to introduce the following trigger conditions (in addition to the already existing trigger conditions relating to the A3 and A5 events) for CHO in NTN:
A new time-based trigger condition, defining a time period, or a time window, when the UE may execute CHO to a candidate target cell.
A new location-based trigger condition, defining a distance threshold from the UE to the source cell and to a candidate target cell, based on which the UE may trigger and execute CHO.
Reuse of the existing A4 event (neighbour becomes better than threshold) as defined in 3GPP TS 38.331.

It may be observed that only the handover mechanisms related to the time-based trigger condition are further discussed herein.

The time-based trigger condition is defined by 3GPP as the time period [t1, t2] associated to each candidate target cell, where t1 is the starting point of the time period represented by a Coordinated Universal Time (UTC), e.g. 00:00:01, and t2 is the end point of the time period represented by a time duration or a timer value, e.g. 10 seconds.

In a recent Change Request (CR) for NR NTN for 3GPP TS 38.331 in Release 17, the time-based condition (condEventT1-r17) is defined in ASN.1 in the ReportConfigNR IE as shown below:

```
  condEventT1-r17 SEQUENCE {
      t1-Threshold-r17
INTEGER (0..549755813887),
      duration-r17
INTEGER (ValueFFS)
    }
```

The duration encoded by the duration-r17 field should be counted as starting from t1, which means that in principle t2=t1+duration=t1-Threshold-r17+duration-r17. The definition of the duration-r17 field (i.e. the different timer/duration values) as agreed by 3GPP TSG RAN2 is 1 . . . 6000.

3GPP further agreed that the time-based trigger condition can only be configured to the UE in combination with one of the signal strength/quality based events A3, A4, or A5. This implies that the UE may only perform CHO to the candidate target cell in the time window defined by T1 and T2 if the signal strength/quality based event is fulfilled within this time frame.

Thus, there currently exist certain challenge(s) that need to be addressed when evolving connected mode mobility solutions in NR to support NTN. For example, a complicating property of a NTN with quasi-earth-fixed cells is that when the responsibility for covering a certain geographical cell area switches from one satellite to another, preferably with a short period of overlap (i.e. both the old and the new satellite cover the cell area simultaneously), this may be assumed to involve a cell change such as, for example, a change of Physical Cell Identifier (PCI). This means that all of the UEs connected in the old cell (to/via the old satellite) have to be handed over to the new cell (and the new satellite) in a short time (i.e. the period of overlap). This may cause increased load on random access processing resources (including the Random Access Channel (RACH) resources) and signaling and processing resources for handover preparation associated with the new cell. If these resources are overloaded, the consequences may involve extended interruption times, handover failures, and radio link failures, as a few examples.

Even in the quasi-earth-fixed cells deployment case, potential handovers to neighboring cells other than the new cell that will take over the coverage of the same area as the current serving cell are possible and have to be taken into account, e.g. triggered by movements of the UE. These other neighboring cells also have limited service times, because of cell switches, where these cell switches may occur at different times.

CHO enables the network to prepare the UE with one or more candidate target cells which may involve one or more candidate target nodes in an inter-node CHO scenario. Configuration of multiple candidate target cells in an inter-node CHO scenario implies increased inter-node signalling since only one candidate target cell can be addressed per XnAP message in a CHO scenario. This applies to the messages sent during the Handover Preparation phase, i.e. the HANDOVER REQUEST message sent from the source gNB to the candidate target gNB and the HANDOVER REQUEST ACKNOWLEDGE message sent from the candidate target gNB to the source gNB, as well as to the HANDOVER CANCEL message which may be sent after handover completion from the source gNB to the candidate target gNB(s) for each candidate target cell not selected by the UE during the evaluation of the CHO execution conditions (to enable release of the CHO configurations for non-selected candidate target cells).

Next Generation (NG) based conditional handover, i.e. with the conditional handover related signaling carried between gNBs via the CN using NGAP messages is not specified in 3GPP Release 16, but this is likely to be specified in later releases. If so, the increase of the inter-node signaling will be even greater if there is no Xn interface between the source and candidate target gNB(s). In this case, NG based conditional handover has to be used, which also involves CN node(s) in the inter-node signaling.

The burden of an increased inter-node signaling may not be so heavy when only a few UEs are configured with CHO in a cell. But, when hundreds or perhaps thousands of UEs are configured with CHO in, for example, a quasi-earth-fixed cell scenario, and more or less all UEs in the cell need to perform CHO to the new cell (replacing the currently serving cell), this may become a problem.

### SUMMARY

Certain aspects of the disclosure and their embodiments may provide solutions to these or other challenges. For example, methods and systems are provided for informing the candidate target network node, during the Handover Preparation phase of a time-based CHO, the time window (or other time related information) during which the UE may perform CHO to the target candidate cell controlled by the candidate target network node.

According to certain embodiments, a method by a source network node for handover of a wireless device in a NTN to a target network node includes transmitting, to the target network node, time information for performing, by the wireless device, the handover to a target cell associated with the target network node.

According to certain embodiments, a source network node for handover of a wireless device in a NTN to a target network node includes processing circuitry configured to transmit, to the target network node, time information for performing, by the wireless device, the handover to a target cell associated with the target network node.

According to certain embodiments, a method by a target network node during handover of a wireless device in a NTN from a source network node to the target network node includes receiving, from the source network node, time information for performing, by the wireless device, the handover to a target cell associated with the target network node.

According to certain embodiments, a target network node includes processing circuitry configured, during handover of a wireless device in a NTN from a source network node to the target network node, to receive, from the source network node, time information for performing, by the wireless device, the handover to a target cell associated with the target network node.

Certain embodiments may provide one or more of the following technical advantage(s). For example, certain embodiments may provide a technical advantage of providing the candidate target network node with information such that the target network node will know or be able to determine when to release the UE and the cell specific resources for a given candidate target cell. Thus, the target network node does not have to wait for a release indicator such as, for example, the XnAP HANDOVER CANCEL message, from the source network node.

As another example, a technical advantage may be that a candidate target network node that is already in the Handover Preparation phase will know for how long time it needs to reserve UE- and cell-specific resources for a given CHO request. This enables a more flexible usage of the candidate target cell resources, such as re-using of contention-free preambles for UEs for which different time windows are configured.

As still another example, the fact that the candidate target network node(s) is aware of the time window in which the UE may perform CHO to a given candidate target cell may also benefit the source network node since the source network node may not need to cancel the CHO (e.g. by sending the XnAP HANDOVER CANCEL message) for the candidate target cell(s) not selected by the UE during the CHO evaluation. As such, certain embodiments may provide a technical advantage of reducing inter-node signaling between source and candidate target network node(s).

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 an example architecture of a satellite network with bent pipe transponders;

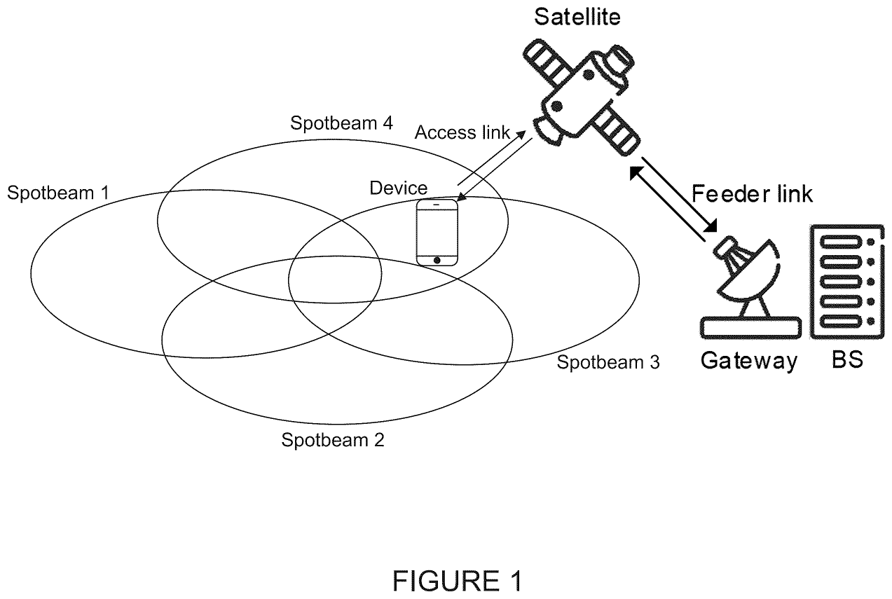

FIG. 2 illustrates a simplified signaling flow between the UE, the source gNB and the target gNB during an Xn-based inter-gNB handover in NR;

FIGS. 3A-3B illustrate an inter-gNB Conditional Handover in NR;

FIG. 4 illustrates an example communication system, according to certain embodiments;

FIG. 5 illustrates an example UE, according to certain embodiments;

FIG. 6 illustrates an example network node, according to certain embodiments;

FIG. 7 illustrates a block diagram of a host, according to certain embodiments;

FIG. 8 illustrates a virtualization environment in which functions implemented by some embodiments may be virtualized, according to certain embodiments;

FIG. 9 illustrates a host communicating via a network node with a UE over a partially wireless connection, according to certain embodiments;

FIG. 10 illustrates a method by a source network node for handover of a wireless device in a NTN to a target network node, according to certain embodiments; and

FIG. 11 illustrates a method by a target network node during handover of a wireless device in a NTN from a source network node to the target network node, according to certain embodiments.

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self-Organizing Network (SON), positioning node (e.g. E-SMLC), etc.

Another example of a node is UE, which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

Herein, the terms ‘beam’ and ‘cell’ are used interchangeably unless explicitly noted otherwise.

Though the embodiments described below are described mainly in terms of NR based (including IoT) NTNs, the disclosed embodiments are equally applicable in a NTN based on LTE (including IoT) technology.

The term “network” is used in the solution description to refer to a network node, which typically will be an gNB (e.g. in a NR based NTN), but which may also be a eNB (e.g. in a LTE based NTN), or a base station or an access point in another type of network, or any other network node with the ability to directly or indirectly communicate with a UE.

The terms “source node”, “source network node”, “target node”, “target network node”, “candidate target node”, and “candidate target network node” are often used in the solution description. The “node” in these terms should be understood as typically being a RAN node in a NTN based on NR technology, LTE technology, or any other RAT in which conditional handover or another conditional mobility concept is defined. In an NR based NTN, such a RAN node may be assumed to be a gNB. In an LTE based NTN (including an IoT NTN), such a RAN node may be assumed to be an eNB. Alternatives to, or refinements of, these interpretations are however also conceivable. For instance, a gNB may be an en-gNB, and if a split gNB architecture is applied (dividing the gNB into multiple separate entities or notes), the term “node” may refer to a part of the gNB, such as a gNB-CU (often referred to as just CU), a gNB-DU (often referred to as just DU), a gNB-CU-CP or a gNB-CU-UP. Similarly, an eNB may be an ng-eNB, and if a split eNB architecture is applied (dividing the gNB into multiple separate entities or notes), the term “node” may refer to a part of the eNB, such as an eNB-CU, an eNB-DU, an eNB-CU-CP or an eNB-CU-UP. Furthermore, the “node” in the terms may also refer to an IAB-donor, IAB-donor-CU, IAB-donor-DU, IAB-donor-CU-CP, or an IAB-donor-CU-UP.

When CHO is configured for a UE, a cell to which the UE potentially can connect (i.e. if the CHO execution condition is fulfilled for the cell) is denoted as “candidate target cell”. Similarly, a RAN node controlling a candidate target cell is denoted as “candidate target node” or “candidate target network node”. However, once the UE has detected a fulfilled CHO execution condition for a candidate target cell, this terminology becomes a bit blurred. At this point, during the actual execution of the CHO and when the UE has connected to the new cell, the concerned cell may be referred to as either a “candidate target cell” or a “target cell”. Similarly, a RAN node controlling such a cell, may in this situation be referred to as either a “candidate target node” or a “target node”.

A condition included in a CHO configuration governing the execution of the conditionally configured procedure may be referred to as either a CHO execution condition or a HO execution condition. Similarly, phases of the procedure may be referred to as the Handover Preparation phase, the Handover Execution and/or the Handover Completion phase. Alternatively, the phases may be referred to as the Conditional Handover Preparation phase, the Conditional Handover Execution phase, and/or the Conditional Handover Completion phase.

When writing message names of a communication protocol, two equivalent principles are used in this document. The writing principle “<protocol name> <message name> message”, for example “XnAP HANDOVER CANCEL message”, and the writing principle “<message name> <protocol name> message”, for example “HANDOVER CANCEL XnAP message” are equivalent, both referring to a message (i.e. “<message name>”) of a communication protocol (i.e. “<protocol name>”), e.g. the HANDOVER CANCEL message of the communication protocol XnAP. The same writing format equivalence applies to other communication protocols, such as NGAP.

During the Handover Preparation phase, the source network node sends an inter-node RRC message to the candidate target network node, denoted as the HandoverPreparationInformation message. This inter-node RRC message contains the UE's configuration in the source cell, in particular the RRC related configuration. To convey the HandoverPreparationInformation message to a candidate target network node, the source network node includes it in the HANDOVER REQUEST XnAP message (in case of an Xn based CHO) or in a HANDOVER REQUIRED NGAP message (in case of an NG based CHO), and in case of an NG based CHO, the CN (represented by an AMF) will forward it to the candidate target network node in the HANDOVER REQUEST NGAP message. In this document, the term “Handover Preparation message” or “initial Handover Preparation message” is often used. This term may refer to a HandoverPreparationInformation inter-node RRC message, or a HANDOVER REQUEST XnAP message (including the HandoverPreparationInformation inter-node RRC message) or a HANDOVER REQUIRED/HANDOVER REQUEST NGAP message (including the HandoverPreparationInformation inter-node RRC message).

When accessing a target cell during a HO or a CHO, the first message the UE sends to the target node in the target cell, after having sent a random access preamble and having received a Random Access Response message, is an RRCReconfigurationComplete message, indicating the successful completion of the HO or CHO. It should be noted that this RRCReconfigurationComplete message is often referred to as a Handover Complete message.

According to 3GPP agreements, a time-based CHO execution condition will always be combined with a signal strength/quality CHO execution condition (both of which have to be fulfilled to trigger CHO execution). However, any embodiments described herein that do not assume that the UE monitors a signal strength/quality condition (i.e. an A3, A4 or A5 event) are equally applicable if the UE is configured only with a time-based CHO execution condition. It may be noted that in embodiments describing lack of trigger of the CHO execution within the time window (i.e. between T1 and T2) it may be assumed that a signal strength/quality condition is configured but not fulfilled between T1 and T2.

Most of the network actions disclosed herein are described as being performed in NG-RAN or E-UTRAN (as applied and modified (when applicable) to NTN). In all these different flavors, the source network node and the target network node for which time-based CHO may be prepared may each be:
An NG-RAN node, i.e. a gNB (supporting NR) or a ng-eNB (supporting LTE)
An E-UTRAN node, i.e. an eNB

Then, the inter-node procedures described herein may be between two gNBs, two eNBs, two ng-eNBs or any two RAN nodes from the same RAT or different RATs. Hence, they may be implemented in the XnAP protocol (in the case of NG-RAN nodes connected to 5GC) or X2AP protocol or both.

In other words, the discussions regarding the inter-node procedures and messages may be any of the following:
Inter-node intra-RAT intra-system, such as gNBs over Xn;
Inter-node intra-RAT intra-system, such as ng-eNBs over Xn;
Inter-node intra-RAT intra-system, such as eNBs over X2;
Inter-node inter-RAT intra-system, such as ng-eNBs and gNBs over Xn;
Inter-node inter-RAT inter-system, such as E-UTRAN and NG-RAN, i.e. gNBs/en-eNBs and eNBs over NG and S1

In addition, the procedures described herein involve messages between RAN nodes and CN nodes over NG and S1 interface and between CN nodes from different systems (i.e. between EPC and 5GC) over the N26 interface.

3GPP Rel-17 and Rel-18 NTN architecture for both NR and IoT foresees the gNB or eNB to be located on the ground and the satellite to consist of a transparent payload. This implies that Xn or X2 interfaces, if present, run between pairs of RAN nodes on the ground (this is obviously true also for the NG and S1 interfaces). It is likely that future releases will foresee regenerative satellites, i.e. a satellites that carry a gNB or eNB. In that case, Xn or X2 will be inter-satellite interfaces.

The time-based CHO trigger condition is defined by 3GPP as the time period [t1, t2] associated to each candidate target cell, where T1 is the starting point of the time period represented by a Coordinated Universal Time (UTC), e.g. 00:00:01, and T2 is the end point of the time period represented by a time duration or a timer value, e.g. 10 seconds.

In the running Change Request (CR) for NR NTN for TS 38.331 Release 17, T1 and T2 are defined as the t1-Threshold-r17 and duration-r17 fields in the ReportConfigNR IE, sent to the UE in the RRCReconfiguration message during the (conditional) Handover Preparation phase. The duration encoded by the duration-r17 field should be counted as starting from T1, which means that in principle T2=T1+duration=t1-Threshold-r17+duration-r17.

The target cell configuration (RRCReconfiguration for the UE to use in the candidate target cell, i.e. the Handover Command, which is constructed by the candidate target node) and the CHO execution condition for each candidate target cell provided by the network to the UE is also known as the CHO configuration. The RRCReconfiguration message sent from the source/serving node conveying such a CHO configuration to the UE during the (conditional) Handover Preparation phase may contain a list of CHO configurations. Further CHO configurations may also subsequently be added to the list, and/or configured CHO configurations may be removed from the list, wherein RRCReconfiguration messages are used in both cases. Furthermore, the information provided from the source node to a candidate target node during the CHO preparation phase, i.e. in the HANDOVER REQUEST XnAP message or the HANDOVER REQUIRED and HANOVER REQUEST NGAP message, e.g. the UE's source cell configuration (i.e. the UE context) and the indication that the prepared handover is conditional, is also referred to as a CHO configuration, albeit in the context of configuration information in a candidate target node.

The time period defined by T1 and T2 during which the UE may perform CHO to the candidate target cell is often referred to herein as the “time window”.

Time or time window representation in the initial (conditional) Handover Preparation message.

The term “Handover Preparation message” or “initial Handover Preparation message” may refer to a HandoverPreparationInformation inter-node RRC message, or a HANDOVER REQUEST XnAP message (including the HandoverPreparationInformation inter-node RRC message) or a HANDOVER REQUIRED/HANDOVER REQUEST NGAP message (including the HandoverPreparationInformation inter-node RRC message).

According to certain embodiments, methods and systems are provided for the source network node to inform the candidate target network node of the time window (or other time related information) in which the UE may perform CHO to a given candidate target cell when time-based CHO is configured to the UE. As such, the candidate target network node will know already during the Handover Preparation phase when the UE is expected to perform CHO to a candidate target cell served by the candidate target network node.

According to certain embodiments, the candidate target node may use this information for various purposes such as, for example, when to release the reserved UE and cell specific resources for a given candidate target cell.

The fact that the candidate target node(s) is aware of the time window when the UE may perform CHO to a given candidate target cell, gives the source node the option to not send the XnAP HANDOVER CANCEL message for a candidate target cell not selected by the UE during the evaluation of the CHO execution conditions.

One of the following time or time window related items or any relevant combination of the following time or time window related items can be sent by the source network node to the candidate target network node during the Handover Preparation phase of the CHO.

According to certain particular embodiments, the time window included in the initial Handover Preparation message is represented by two new Information Elements (IEs), or fields, encoded as the t1-Threshold-r17 and duration-r17 fields as defined in the ReportConfigNR IE (i.e. as currently proposed in the running CR for NR NTN for TS 38.331 Release 17). That is, t1-Threshold-r17 is configured as a Coordinated Universal Time (UTC) and duration-r17 as a duration/timer (value range of the duration/timer is not yet agreed in 3GPP TSG2). When receiving this information in the initial Handover Preparation message, the candidate target network node will know the exact time span when the UE may perform a CHO execution attempt to the associated candidate target cell. The candidate target network node may thus choose to release the reserved cell resources and UE resources associated with the CHO configuration upon expiration of the time window. Optionally, the candidate target network node may also add a margin to the indicated time window before it releases the reserved cell resources and UE resources associated with the CHO configuration. This margin, for example, may represent (or take into account) the estimated transmission time or propagation time between the UE and the candidate target node, or may represent (or take into account) the Round-Trip Time (RTT) between the UE and the candidate target node, or may represent (or take into account) the estimated time of completion of the CHO execution phase (e.g. up to and including reception of the RRCReconfigurationComplete message constituting the Handover Complete message).

In a more particular embodiment, the time window included in the initial Handover Preparation message is represented by two new IEs, or fields, where only the IE or the field indicating the start time of the time window (T1) is encoded as the t1-Threshold-r17 field in the ReportConfigNR IE. The other IE, or field, indicates the latest time the UE can execute the CHO and, thus, in practice also indicates the time when the candidate target network node may release the reserved cell resources and UE resources associated to the CHO request. The time in this IE, or field, may e.g. represent the time duration as provided to the UE in the duration-r17 field (included in the ReportConfigNR IE) plus a margin representing the estimated transmission time between the UE and the candidate target network node, or a margin representing the estimated RTT between the UE and the candidate target network node, or a margin representing the estimated time of completion of the CHO execution phase (e.g. up to and including reception of the RRCReconfigurationComplete message constituting the Handover Complete message). The time in this IE, or field, is either defined as a time duration, timer, a time period (where this time duration, timer or time period is to be started at T1) or as a UTC.

In another particular embodiment, the source network node also includes an explicit indicator in the initial Handover Preparation message informing the candidate target network node that the reserved cell resources and UE resources associated to the CHO request, can be released at the end of the time window. Consequently, the candidate target network node can release the reserved resources at the end of the time window, without having to wait for a potential release or handover cancel message (e.g. an XnAP HANDOVER CANCEL message) from the source network node. As an alternative, an explicit indicator may be included in the initial Handover Preparation message to inform the candidate target network node that the source network node will not send any HANDOVER CANCEL XnAP message to the candidate target network node if the CHO is executed towards another candidate target network node/cell. As a consequence, the candidate target network node itself needs to initiate release of the reserved resources (unless the UE executes the CHO towards the candidate target network node/cell), preferably when the time has passed T2 (e.g. when the time duration, timer or time period which together with T1 represents T2 has elapsed or expired), optionally with some margin to account for propagation delays (and/or other delays involved in the network access process, e.g. the estimated time of completion of the CHO execution phase (e.g. up to and including reception of the RRCReconfigurationComplete message constituting the Handover Complete message)).

In another particular embodiment, the source network node only indicates the end of the time window (T2) to the candidate target network node in the initial Handover Preparation message. The information is included as a new IE, or field, e.g. represented as a UTC. The new IE, or field, may be encoded in the same format as the t1-Threshold-r17 field in the ReportConfigNR IE. For example, the source network node performs the conversion to UTC from the T1 plus time duration/timer/time period represented by T2. When receiving this information, the candidate target network node will know when, at the latest, the UE may perform a CHO execution attempt to the associated candidate target cell. In another particular embodiment, the source network node includes a value representing T2 as a new IE, or field, in the initial Handover Preparation message. The new IE, or field, may be encoded as the duration-r17 field in the ReportConfigNR IE. Thus, the conversion to UTC or other relevant time representation (such as related to the time structure of the radio interface, e.g. in terms of SFN and slot number (and possibly Hyper SFN)) is performed by the candidate target network node.

In another particular embodiment, the source network node only includes an indication of the start of the time window, i.e. the time represented by T1, e.g. encoded as the t1-Threshold-r17 field (or as another UTC encoding), as a new IE, or field, in the initial Handover Preparation message. When receiving this information, the candidate target network node will know when, at the earliest, the UE may perform a CHO execution attempt to the associated candidate target cell. Not knowing the end of the time window, as an option for a decision to release the reserved cell resources and UE resources associated with the CHO configuration (when the UE does not execute the CHO to the concerned candidate target cell), the candidate target network node may instead rely on information (which may be signaled to or configured in the candidate target network node) about the end of service time of the source cell (i.e. when the source cell will stop serving the concerned geographical area), or, as another option, the candidate target network node may rely on knowledge of the maximum configurable length of the time window.

In yet another particular embodiment, the source network node includes the “serving cell stop time” as a new IE, or field, in the initial Handover Preparation message. The “serving cell stop time” is in the running CR for NR NTN for TS 38.331 Release 17 defined as the time when the serving (source) cell in a quasi-earth-fixed cell scenario, stops serving the area it is currently covering. The “serving cell stop time”, in the running CR defined as t-Service-r17, is currently proposed to be broadcasted in System Information Block 2 (SIB2) in each quasi-earth-fixed cell in an NTN deployment. The new “serving cell stop time” IE, or field, included in the initial Handover Preparation message can be encoded as the t-Service field included in SIB2 (or potentially included in another SIB message if agreed by 3GPP RAN2), representing a UTC, or using another way of encoding a UTC. When receiving this information, the candidate target network node will know the time when the source cell will stop serving the UE and by that, when, at the latest, the UE may (or at least preferably should) perform a CHO execution attempt to the associated candidate target cell. The candidate target network node may, thus, use this “serving cell stop time” indication as a basis for a decision to release the reserved cell resources and UE resources associated with the CHO configuration in the concerned candidate target cell.

In all the above described embodiments, the time/time window information may be included in the HandoverPreparationInformation inter-node RRC message or as IE(s) on the XnAP or NGAP level (i.e. as IE(s) separate from the container carrying the HandoverPreparationInformation inter-node RRC message in the HANDOVER REQUEST XnAP message and/or the HANDOVER REQUIRED and HANDOVER REQUEST NGAP messages).

Note that in all the methods, variants, and options described above related to transfer of time or time window related information from the source network node to a candidate target network node, where conditions for, or decisions of, release of reserved cell resources and UE resources associated with a candidate target cell, the discussion about the release of resources assumes the case where the UE did not execute (or did not successfully execute) the CHO in the candidate target network node. If the UE does (successfully) execute the CHO in the candidate target network node, the candidate target network node may immediately release any reserved cell resources and UE resources associated with CHO configurations for the same UE in any other candidate target cell controlled by the same candidate target network node.

### Source Network Node Signaling in Initial (Conditional) Handover Preparation Message

The CHO related time information included in the initial (conditional) Handover Preparation message as described herein can be any of the time or time window related items, or any relevant combination of the time or time window related items, as described above.

In a particular embodiment, the source network node sends an initial Handover Preparation message with the CHO related time information included, when requesting a time-based CHO for a candidate target cell. In one implementation the CHO related time information can be added as an additional Information Element (IE) in the initial Handover Preparation message sent from the source network node to the target network node. In another implementation, the CHO related time information can be included in the RRC Context included in the Handover Preparation message signaled from the source network node to the target network node.

In other words, the CHO related time information may be included in the HandoverPreparationInformation inter-node RRC message or as IE(s) on the XnAP or NGAP level (i.e. as IE(s) separate from the container carrying the HandoverPreparationInformation inter-node RRC message in the HANDOVER REQUEST XnAP message and/or the HANDOVER REQUIRED and HANDOVER REQUEST NGAP messages).

An example of a possible implementation of the alternatives above, taking XnAP (3GPP TS 38.423) HANDOVER REQUEST message as baseline, is shown below (IEs to be added to current signaling are italicized):

### 9.1.1.1 Handover Request

This message is sent by the source NG-RAN node to the target NG-RAN node to request the preparation of resources for a handover.
Direction: source NG-RAN node→target NG-RAN node.

| | | | IE type and | Semantics | | Assigned |
|---|---|---|---|---|---|---|
| IE/Group Name | Presence | Range | reference | description | Criticality | Criticality |
| Message Type | M | | 9.2.3.1 | | YES | reject |
| Source NG-RAN node UE | M | | NG-RAN | Allocated at the source NG-RAN | YES | reject |
| XnAP ID reference | | | node UE | node | | |
| | | | XnAP ID | | | |
| | | | 9.2.3.16 | | | |
| Cause | M | | 9.2.3.2 | | YES | reject |
| Target Cell Global ID | M | | 9.2.3.25 | Includes either an E-UTRA CGI | YES | reject |
| | | | | or an NR CGI | | |
| GUAMI | M | | 9.2.3.24 | | YES | reject |
| UE Context Information | | 1 | | | YES | reject |
| >NG-C UE associated | M | | AMF UE | Allocated at the AMF on the | — | |
| Signalling reference | | | NGAP ID | source NG-C connection. | | |
| | | | 9.2.3.26 | | | |
| >Signalling TNL association | M | | CP | This IE indicates the AMF's IP | — | |
| address at source NG-C | | | Transport | address of the SCTP association | | |
| side | | | Layer | used at the source NG-C interface | | |
| | | | Information | instance. Note: If no UE TNLA | | |
| | | | 9.2.3.31 | binding exists at the source | | |
| | | | | NG-RAN node, the source | | |
| | | | | NG-RAN node indicates the TNL | | |
| | | | | association address it would have | | |
| | | | | selected if it would have had to | | |
| | | | | create a UE TNLA binding. | | |
| >UE Security Capabilities | M | | 9.2.3.49 | | — | |
| >AS Security Information | M | | 9.2.3.50 | | — | |
| >Index to RAT/Frequency | O | | 9.2.3.23 | | — | |
| Selection Priority | | | | | | |
| >UE Aggregate Maximum | M | | 9.2.3.17 | | — | |
| Bit Rate | | | | | | |
| >PDU Session Resources | | 1 | 9.2.1.1 | Similar to NG-C signalling, | — | |
| To Be Setup List | | | | containing UL tunnel information | | |
| | | | | per PDU Session Resource; and in | | |
| | | | | addition, the source side QoS | | |
| | | | | flow ⇔ DRB mapping | | |
| >RRC Context | M | | OCTET | Either includes the | — | |
| | | | STRING | HandoverPreparationInformation | | |
| | | | | message as defined in subclause | | |
| | | | | 10.2.2. of TS 36.331 [14], or the | | |
| | | | | HandoverPreparationInformation-NB | | |
| | | | | message as defined in subclause | | |
| | | | | 10.6.2 of TS 36.331 [14], if the | | |
| | | | | target NG-RAN node is an ng-eNB, | | |
| | | | | or the | | |
| | | | | HandoverPreparationInformation | | |
| | | | | message as defined in subclause | | |
| | | | | 11.2.2 of TS 38.331 [10], if the | | |
| | | | | target NG-RAN node is a gNB. | | |
| >Location Reporting | O | | 9.2.3.47 | Includes the necessary parameters | — | |
| Information | | | | for location reporting. | | |
| >Mobility Restriction List | O | | 9.2.3.53 | | — | |
| >Management Based MDT | O | | MDT PLMN | | YES | ignore |
| PLMN List | | | List | | | |
| | | | 9.2.3.133 | | | |
| >5GC Mobility Restriction | O | | 9.2.3.100 | | YES | ignore |
| List Container | | | | | | |
| >NR UE Sidelink Aggregate | O | | 9.2.3.107 | This IE applies only if the UE is | YES | ignore |
| Maximum Bit Rate | | | | authorized for NR V2X services. | | |
| >LTE UE Sidelink | O | | 9.2.3.108 | This IE applies only if the UE is | YES | ignore |
| Aggregate Maximum Bit | | | | authorized for LTE V2X services. | | |
| Rate | | | | | | |
| >UE Radio Capability ID | O | | 9.2.3.138 | | YES | reject |
| Trace Activation | O | | 9.2.3.55 | | YES | ignore |
| Masked IMEISV | O | | 9.2.3.32 | | YES | ignore |
| UE History Information | M | | 9.2.3.64 | | YES | ignore |
| UE Context Reference at | O | | | | YES | ignore |
| the S-NG-RAN node | | | | | | |
| >Global NG-RAN Node ID | M | | 9.2.2.3 | | — | |
| >S-NG-RAN node UE | M | | NG-RAN | | — | |
| XnAP ID | | | node UE | | | |
| | | | XnAP ID | | | |
| | | | 9.2.3.16 | | | |
| Conditional Handover | O | | | | YES | reject |
| Information Request | | | | | | |
| >CHO Trigger | M | | ENUMERATED | | — | |
| | | | (CHO- | | | |
| | | | initiation, | | | |
| | | | CHO- | | | |
| | | | replace, ...) | | | |
| >Target NG-RAN node UE | C- | | NG-RAN | Allocated at the target NG-RAN | — | |
| XnAP ID | ifCHOmod | | node UE | node | | |
| | | | XnAP ID | | | |
| | | | 9.2.3.16 | | | |
| >Estimated Arrival | O | | INTEGER | | — | |
| Probability | | | (1..100) | | | |
| >Handover Window Start | O | | INTEGER | Corresponds to t1-Threshold-r17 | — | |
| | | | (0..549755813887) | defined in TS 38.331 [10] | | |
| >Handover Window Stop | O | | Type FFS | Corresponds to duration-r17 | — | |
| | | | | defined in TS 38.331 [10] | | |
| >Release of Reserved | O | | Type FFS | Same encoding as duration-r17 | — | |
| Resources | | | | defined in TS 38.331 [10] | | |
| >Serving Cell Stop Time | O | | Type FFS | Same encoding as t-Service-r17 | — | |
| | | | | defined in TS 38.331 [10] | | |
| NR V2X Services Authorized | O | | 9.2.3.105 | | YES | ignore |
| LTE V2X Services | O | | 9.2.3.106 | | YES | ignore |
| Authorized | | | | | | |
| PC5 QoS Parameters | O | | 9.2.3.109 | This IE applies only if the UE is | YES | ignore |
| | | | | authorized for NR V2X services. | | |
| Mobility Information | O | | BIT STRING | Information related to the handover; | YES | ignore |
| | | | (SIZE (32)) | the source NG-RAN node provides | | |
| | | | | it in order to enable later analysis of | | |
| | | | | the conditions that led to a wrong | | |
| | | | | HO. | | |
| UE History Information from | O | | 9.2.3.110 | | YES | ignore |
| the UE | | | | | | |
| IAB Node Indication | O | | ENUMERATED | | YES | reject |
| | | | (true, ...) | | | |

If Xn is not deployed between the source and target RAN nodes, the same information can be signaled in the Source NG-RAN Node to Target NG-RAN Node Transparent Container IE, signaled through the 5GC in the NGAP HANDOVER REQUIRED and HANDOVER REQUEST messages (3GPP TS 38.413). An example of a possible implementation is shown below (IEs to be added to current signaling are italicized):

### 9.3.1.29 Source NG-RAN Node to Target NG-RAN Node Transparent Container

This IE is produced by the source NG-RAN node and is transmitted to the target NG-RAN node. For inter-system handovers to 5G, the IE is transmitted from the external handover source to the target NG-RAN node.
This IE is transparent to the 5GC.

| | | | IE type and | Semantics | | Assigned |
|---|---|---|---|---|---|---|
| IE/Group Name | Presence | Range | reference | description | Criticality | Criticality |
| RRC Container | M | | OCTET STRING | Includes the RRC | — | |
| | | | | HandoverPreparationInformation | | |
| | | | | message as defined in TS | | |
| | | | | 38.331 [18] if the target is a | | |
| | | | | gNB. Includes the RRC | | |
| | | | | HandoverPreparationInformation | | |
| | | | | message as defined in TS | | |
| | | | | 36.331 [21] if the target is an | | |
| | | | | ng-eNB. | | |
| PDU Session Resource | | 0..1 | | For intra-system handovers in | — | |
| Information List | | | | NG-RAN. | | |
| >PDU Session | | 1..<maxnoofPDUSessions> | | | — | |
| Resource Information | | | | | | |
| Item | | | | | | |
| >>PDU Session ID | M | | 9.3.1.50 | | — | |
| >>QoS Flow | | 1 | | | — | |
| Information List | | | | | | |
| >>>QoS Flow | | 1..<maxnoofQoSFlows> | | | — | |
| Information Item | | | | | | |
| >>>>QoS Flow | M | | 9.3.1.51 | | — | |
| Identifier | | | | | | |
| >>>>DL Forwarding | O | | 9.3.1.33 | | — | |
| >>>>UL Forwarding | O | | 9.3.1.118 | | YES | ignore |
| >>DRBs to QoS Flows | O | | 9.3.1.34 | | — | |
| Mapping List | | | | | | |
| E-RAB Information List | | 0..1 | | For inter-system handovers to | — | |
| | | | | 5G. | | |
| >E-RAB Information | | 1..<maxnoofE-RABs> | | | — | |
| Item | | | | | | |
| >>E-RAB ID | M | | 9.3.2.3 | | — | |
| >>DL Forwarding | O | | 9.3.1.33 | | — | |
| Target Cell ID | M | | NG-RAN CGI | | — | |
| | | | 9.3.1.73 | | | |
| Index to RAT/Frequency | O | | 9.3.1.61 | | — | |
| Selection Priority | | | | | | |
| UE History Information | M | | 9.3.1.95 | | — | |
| SgNB UE X2AP ID | O | | 9.3.1.127 | Allocated at the Source en-gNB | | |
| UE History Information | O | | 9.3.1.166 | | YES | ignore |
| from UE | | | | | | |
| Handover Window Start | O | | INTEGER | Corresponds to t1-Threshold-r17 | — | |
| | | | (0..549755813887) | defined in TS 38.331 [10] | | |
| Handover Window Stop | O | | TypeFFS | Corresponds to duration-r17 | — | |
| | | | | defined in TS 38.331 [10] | | |
| Release of Reserved | O | | TypeFFS | Same encoding as duration-r17 | — | |
| Resources | | | | defined in TS 38.331 [10] | | |
| Serving Cell Stop Time | O | | TypeFFS | Same encoding as t-Service-r17 | — | |
| | | | | defined in TS 38.331 [10] | | |

### Source Node Signaling in the Handover Completion Phase

During the Handover Completion phase of the CHO, the candidate target network node sends the XnAP HANDOVER SUCCESS message to the source network node to inform that the UE has successfully accessed the candidate target cell served by the candidate target network node. If more than one candidate target cell was configured to the UE during the Handover Preparation phase, the source network node will now send the XnAP HANDOVER CANCEL message towards the other signaling connection(s) or other candidate target network node(s) (i.e. for each candidate target cell not selected by the UE) to cancel the CHO and, thus, to initiate a release of the reserved resources in the target network node(s) associated to the CHO request.

When a time-based CHO with multiple candidate target cells is configured during the Handover Preparation phase, all candidate target network nodes are informed of the time window (or the time when the time window elapse) in which the UE may attempt CHO to a given candidate target cell. As an alternative, or as a complement, each candidate target network node may also be informed of the serving time of the source cell (e.g. according to the broadcasted “serving cell stop time”). Based on this information, each candidate target network node can for each candidate target cell not selected by the UE, at the end of the time window (or when the source cell stops serving the concerned UE), cancel the handover preparation by releasing the resources reserved in the associated CHO request. In other words, the candidate target network node may cancel the CHO preparation and release the reserved cell and UE resources even if a release or handover cancel message (e.g. the XnAP HANDOVER CANCEL) is not sent from the source network node.

This will benefit the source network node since the source network node does not need to send, for example, the XnAP HANDOVER CANCEL message for a candidate target cell not selected by the UE during the CHO evaluation.

In one particular embodiment, after receiving the XnAP HANDOVER SUCCESS message from a candidate target network node during a time-based CHO, the source network node determines not to send the XnAP HANDOVER CANCEL message for a candidate target cell not selected by the UE. The decision is based on that each candidate target network node already knows (informed during the Handover Preparation phase) the time window (or the end of the time window) in which the UE is allowed to perform CHO to a given candidate target cell served by the candidate target network node, thus the candidate target network node will release the resources reserved in the associated CHO request without any further message/indicator from the source network node.

In a variant of this particular embodiment, the source network node also evaluates the remaining time before the time window elapse (in which the UE may attempt CHO to a given candidate target cell) after receiving the XnAP HANDOVER SUCCESS message from a candidate target network node during a time-based CHO.

If the remaining time until the expiration of the time window for a given candidate target cell (not selected by the UE) is longer than a network specified threshold (e.g. operator configured or in software hardcoded parameter), the source network node may decide to send the XnAP HANDOVER CANCEL message for that candidate target cell. But, if the remaining time for a given candidate target cell (not selected by the UE) is shorter than a network specified threshold, the source network node may decide to not send the XnAP HANDOVER CANCEL message for that candidate target cell.

In another variant of this particular embodiment, the decision to not send the XnAP HANDOVER CANCEL message for a candidate target cell (not selected by the UE) is based on the candidate target network node (serving the candidate target cell) is aware of the serving time of the source cell. Based on this information, the candidate target network node knows when the source cell will stop serving the UE and by that, when, at the latest, the UE may (or at least preferably should) perform a CHO execution attempt to the associated candidate target cell. The candidate target network node may, thus, use the serving time of the source cell as a basis for a decision to release the reserved cell resources and UE resources associated with the CHO configuration in the concerned candidate target cell, thus the candidate target network node will release the resources reserved in the associated CHO request without any further message/indicator from the source network node. The serving time of the source cell (e.g. according to the broadcasted “serving cell stop time”) could be signaled to the candidate target network node during the (conditional) Handover Preparation phase, or the “serving cell stop time” of surrounding/neighbor cells could be pre-configured in the candidate target network node (as in all nodes in the NTN deployment).

In yet another particular embodiment, the source network node also evaluates the remaining time before the source cell stops serving the area it is currently covering (e.g. according to the broadcasted “serving cell stop time”) after receiving the XnAP HANDOVER SUCCESS message from a candidate target network node during a time-based CHO. If the remaining time until the service stop time for the source cell is longer than a network specified threshold (e.g. operator configured or in software hardcoded parameter), the source network node may decide to send the XnAP HANDOVER CANCEL message for non-selected candidate target cell(s). But, if the remaining time until the service stop time for the source cell is shorter than a network specified threshold, the source network node may decide to not send the XnAP HANDOVER CANCEL message for non-selected candidate target cell. This particular embodiment may be suitable when the source network node sends the source cell's service stop time to the target network node (especially when the source cell's service stop time is sent but not T2), or when the candidate target network node in other ways has been made aware of the source cell's service stop time (especially if the candidate target network node is not aware of T2).

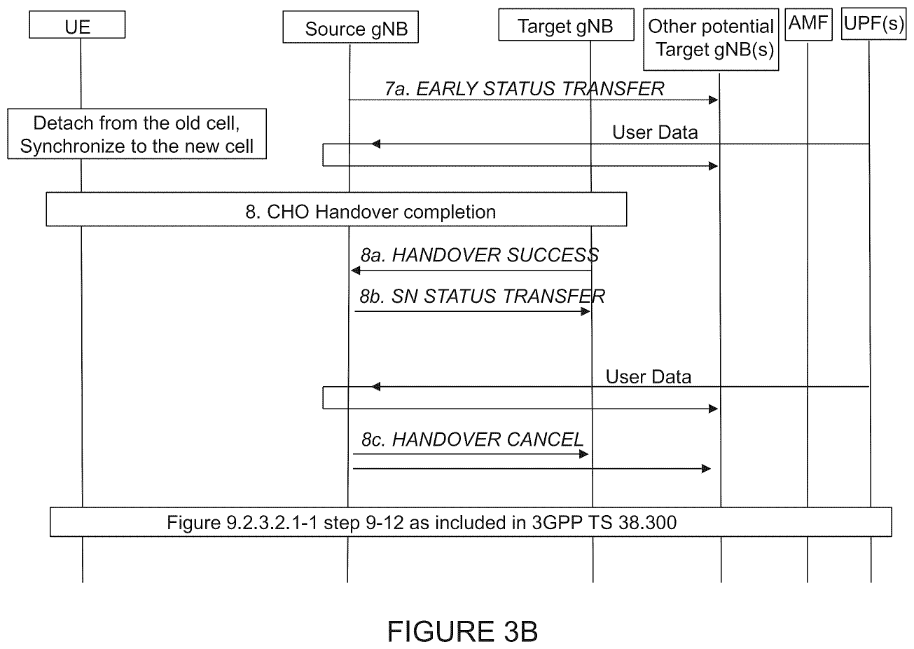

FIG. 4 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3rd Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102 and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 4 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

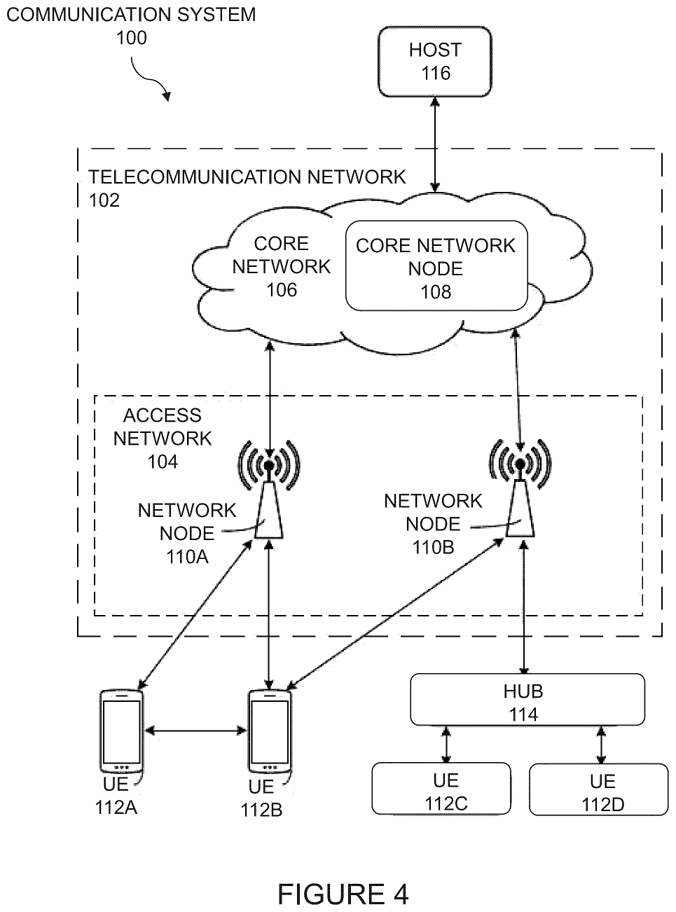

FIG. 5 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 5. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software, or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected, an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 5.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

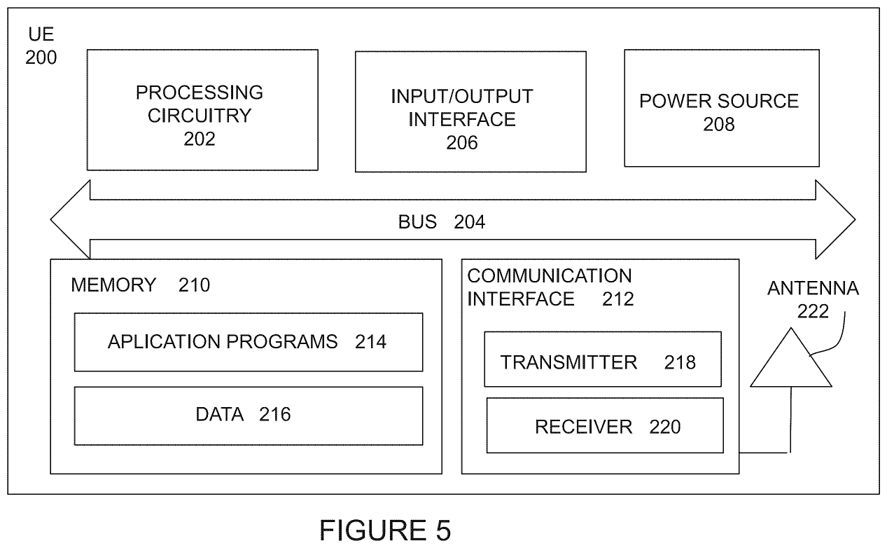

FIG. 6 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 6 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

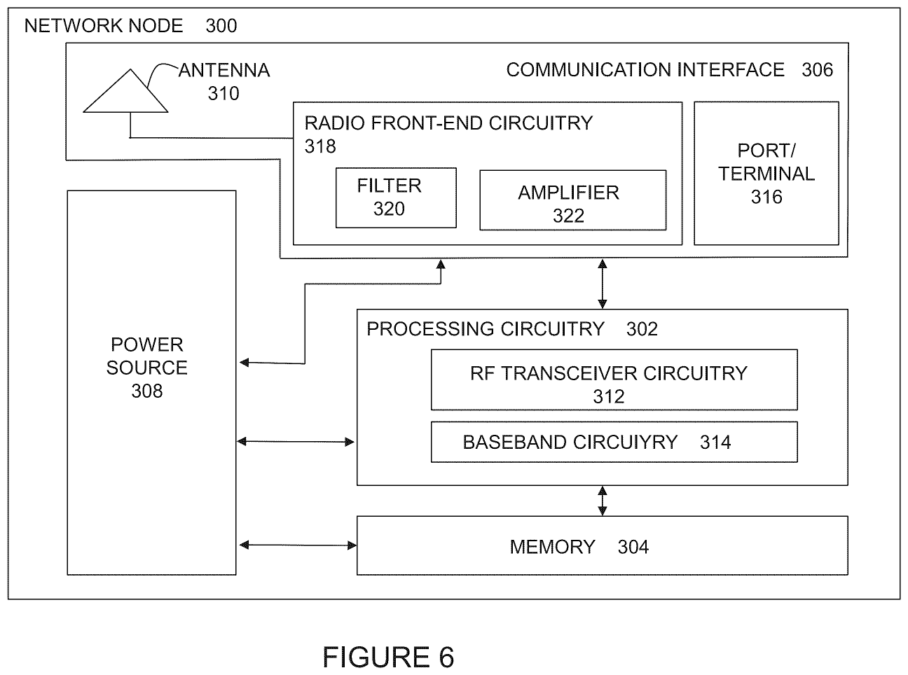

FIG. 7 is a block diagram of a host 400, which may be an embodiment of the host 116 of FIG. 4, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

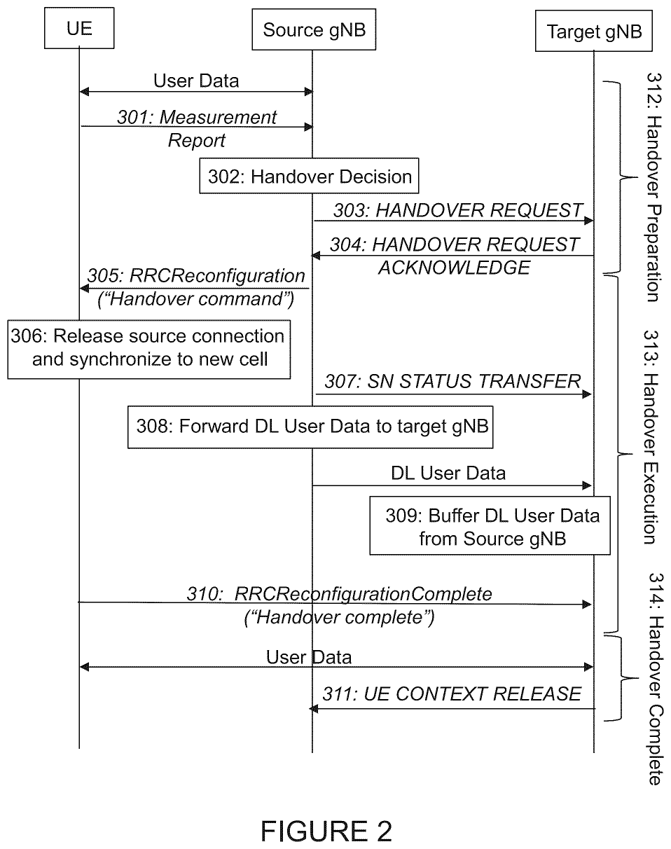

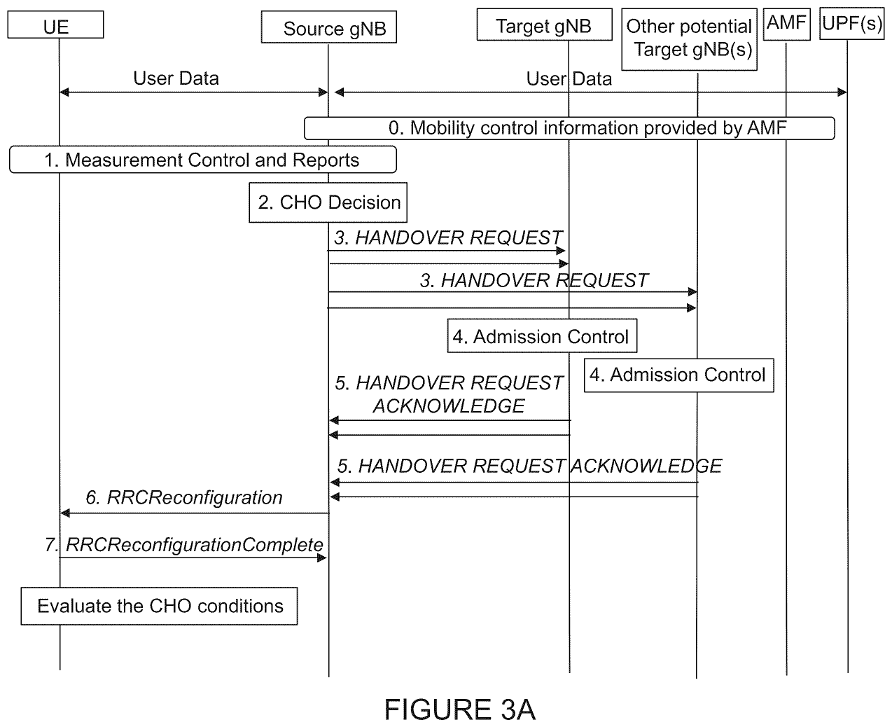

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

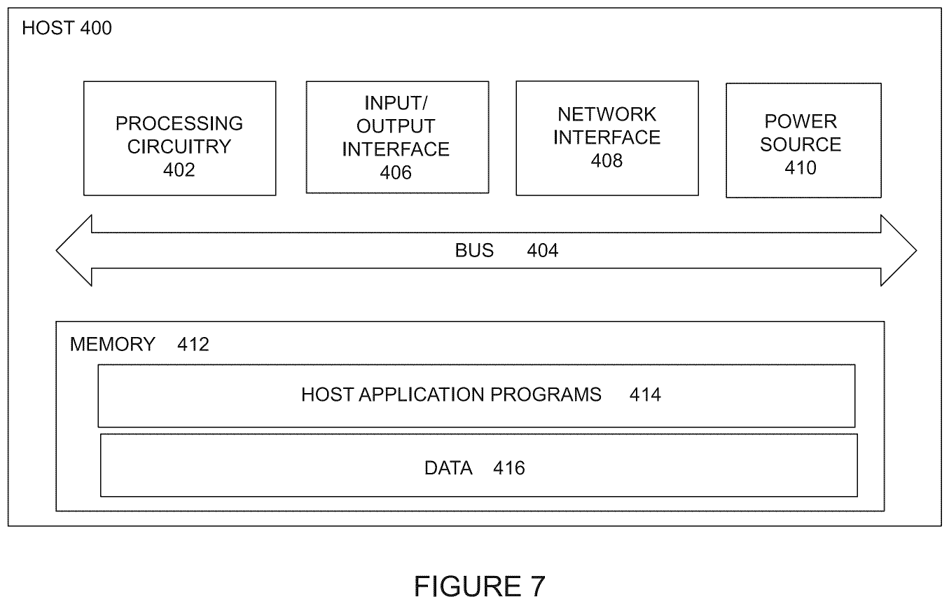

FIG. 8 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

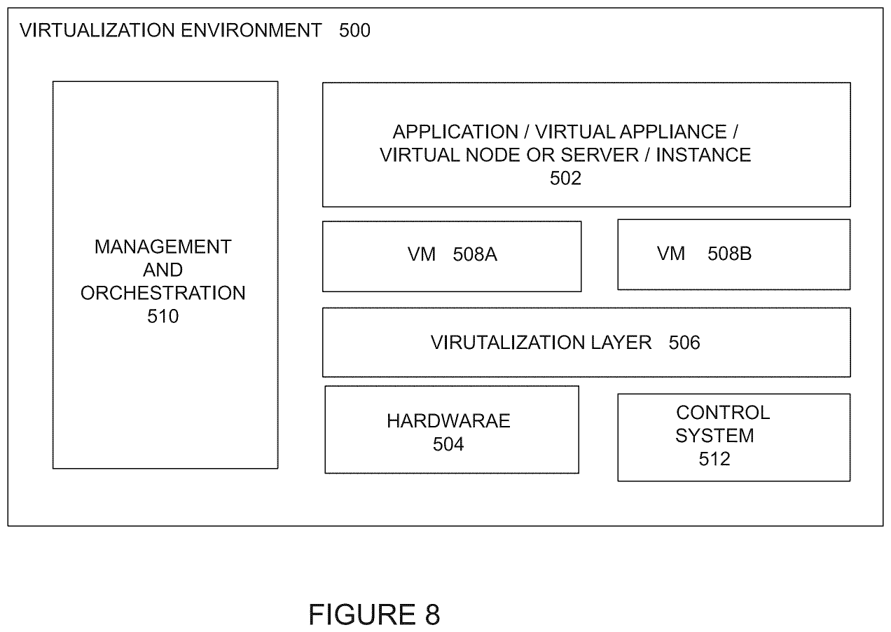

FIG. 9 shows a communication diagram of a host 602 communicating via a network node 604 with a UE 606 over a partially wireless connection in accordance with some embodiments.

Example implementations, in accordance with various embodiments, of the UE (such as a UE 112a of FIG. 4 and/or UE 200 of FIG. 5), network node (such as network node 110a of FIG. 4 and/or network node 300 of FIG. 6), and host (such as host 116 of FIG. 4 and/or host 400 of FIG. 7) discussed in the preceding paragraphs will now be described with reference to FIG. 9.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 4) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency, and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency, and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionalities may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device but are enjoyed by the computing device as a whole, and/or by end users and a wireless network generally.

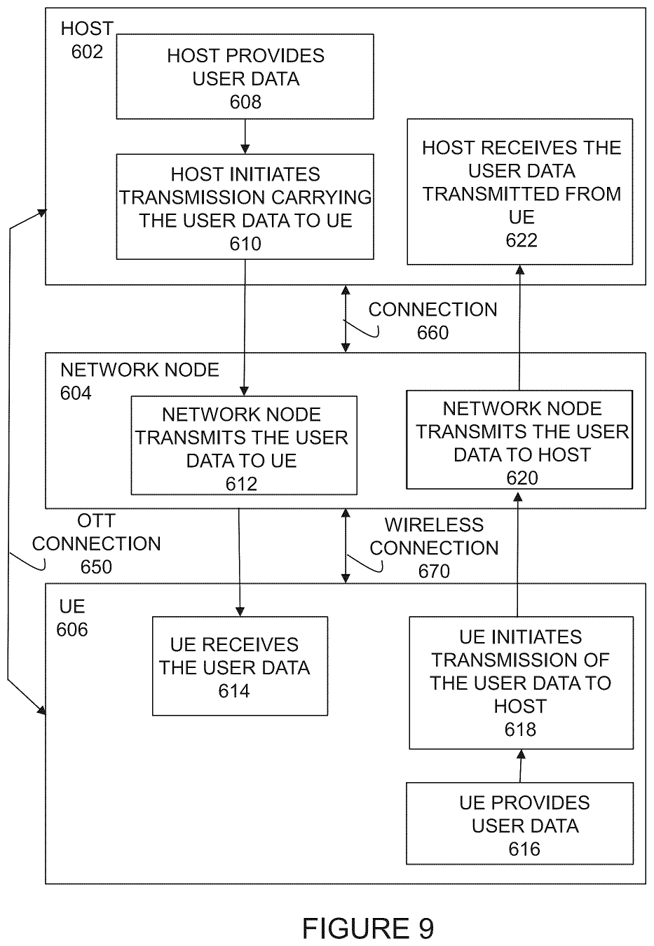

FIG. 10 illustrates a method 700 by a source network node 110A for handover of a wireless device in a NTN to a target network node 110B, according to certain embodiments. The method includes transmitting, to the target network node, at step 702, time information for performing, by the wireless device 112, the handover to a target cell associated with the target network node 110B.

In a particular embodiment, the time information includes at least one of: a start time of a time window, an end time of a time window, a time window duration, and a serving cell stop time.

In a particular embodiment, the handover comprises a CHO.

In a particular embodiment, the target network node is a candidate target network node.

In a particular embodiment, the time information is transmitted to the target network node in a handover configuration.

In a particular embodiment, the time information is transmitted to the target network node in at least one of: a Handover Preparation message, an initial Handover Preparation message, a X2AP HANDOVER REQUEST message, a XnAP HANDOVER REQUEST message, a NGAP HANDOVER REQUIRED message, a NGAP HANDOVER REQUEST message, a S1AP HANDOVER REQUIRED message, and a S1AP HANDOVER REQUEST message.

In a particular embodiment, the time information or another message transmitted to the target network node indicates that the target network node can release at least one resource reserved for the wireless device at an expiration of a time window duration.

In a particular embodiment, based on the target network node 110B having received the time information, the source network node 110A determines not to transmit a handover cancel message to at least one other target network node 110B.

In a particular embodiment, the source network node 110A determines that at least one other target network node received the time information associated with the handover of the wireless device. The source network node 110A then determines whether a remaining time left before an expiration of a time duration window is greater than a minimum threshold. Based on the remaining time left before the expiration of the time window duration being greater than a minimum threshold, the source network node 110A determines to transmit, to the at least one other target network node 110B, a handover cancel message to trigger a release of at least one resource reserved for handover of the wireless device by the at least one other target network node 110B.

In a particular embodiment, the source network node 110A determines that at least one other target network node 110B received a serving cell stop time for a source cell associated with the source network node. Based on the at least one other target network node 110B having received the serving cell stop time for the source cell, the source network node 110A determines not to transmit a handover cancel message to the at least one other target network node 110B.

In a particular embodiment, the source network node 110A determines that at least one other target network node 110B received a serving cell stop time for a source cell associated with the source network node 110A. The source network node 110A then determines whether a remaining time left before an expiration of the serving cell stop time is greater than a minimum threshold. Based on the remaining time left before the expiration of the serving cell stop time being greater than a minimum threshold, the source network node 110A determines to transmit, to the at least one other target network node 110B, a handover cancel message to trigger a release of at least one resource reserved for handover of the wireless device by the at least one other target network node 110B.

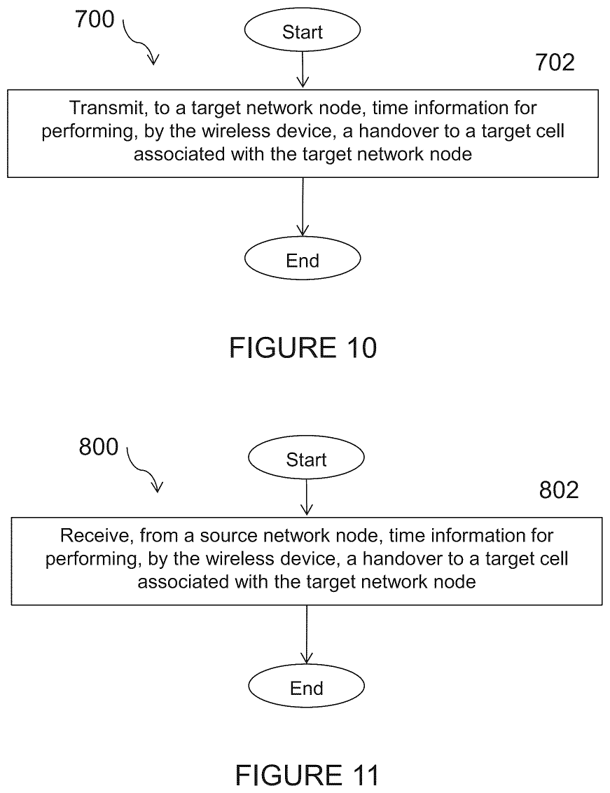

FIG. 11 illustrates a method 800 by a target network node 110B during handover of a wireless device 112 in a NTN from a source network node 110A to the target network node 110B, according to certain embodiments. The method includes receiving, from the source network node 110A, at step 802, time information for performing, by the wireless device 112, the handover to a target cell associated with the target network node 110B.

In a particular embodiment, the time window includes at least one of: a start time of a time window, an end time of the time window, a time window duration, and a serving cell stop time.

In a particular embodiment, the handover comprises as CHO.

In a particular embodiment, the target network node is a candidate target network node.

In a particular embodiment, the time information is received from the source network node 110A in a handover configuration.

In a particular embodiment, the time information is received from the source network node 110A in at least one of: a Handover Preparation message, an initial Handover Preparation message, a X2AP HANDOVER REQUEST message, a XnAP HANDOVER REQUEST message, a NGAP HANDOVER REQUIRED message, a NGAP HANDOVER REQUEST message, a S1AP HANDOVER REQUIRED message, and a S1AP HANDOVER REQUEST message.

In a particular embodiment, based on the time information, the target network node 110B reserves at least one resource for the handover of the wireless device 112 to the target cell.

In a particular embodiment, the time information or another message received from the source network node 110A indicates that the target network node 110B can release the at least one resource reserved for the wireless device 112 when a time window duration expires.

In a particular embodiment, the target network node 110B determines that a time window duration has expired and releases the at least one resource that was reserved for the handover of the wireless device to the target cell.

In a particular embodiment, the target network node 110B determines that a time window duration has expired and determines that at least a margin of time has passed after the time window duration has expired. Based on the time window duration expiring and the margin of time passing after the expiration of the time window duration, the target network node 110B releases the at least one resource that was reserved for the handover of the wireless device 12 to the target cell.

In a particular embodiment, the target network node 110B takes at least one action based on the time information, and the at least one action includes at least one of: determining a latest time that the wireless device 112 can successfully execute the handover to the target cell associated with the target network node 110B; determining that the latest time that the wireless device 112 can successfully execute the handover to the target cell has passed and releasing at least one resource reserved for the handover of the wireless device 112 to the target cell; determining a period of time to reserve at least one resource for the handover of the wireless device 112 to the target cell; and determining a time to release at least one resource reserved for the handover of the wireless device 112 to the target cell.

In a particular embodiment, the target network node 110B determines, based on the time information, a serving cell stop time associated with a time that the source network node 110A will stop serving the wireless device in a serving cell. Based on the serving cell stop time, the target network node 110B performs at least one of: determining a latest time that the wireless device can successfully execute the handover to the target cell associated with the target network node; determining a period of time to reserve at least one resource for the handover of the wireless device to the target cell; and determining a time to release at least one resource reserved for the handover of the wireless device to the target cell.

### EXAMPLE EMBODIMENTS

### Group A Example Embodiments

Example Embodiment A1. A method by a user equipment for time-based handover in Non-Terrestrial Networks, the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for time-based handover in Non-Terrestrial Networks, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a source network node for handover of a wireless device in a Non-Terrestrial Network to a target network node, the method comprising: transmitting time information to the target network node, the time information indicating at least one time window for performing, by the wireless device, the handover to at least one target cell associated with the target network node.

Example Embodiment C2. The method of Example Embodiment C1, wherein the handover comprises as conditional handover (CHO).

Example Embodiment C3. The method of any one of Example Embodiments C1 to C2, wherein the time window comprises at least one of: a start time, an end time, a time window duration, and/or a serving cell stop time.

Example Embodiment C4. The method of any one of Example Embodiments C to C3, wherein the time information is transmitted to the target network node in a handover configuration.

Example Embodiment C5. The method of any one of Example Embodiments C1 to C4, wherein the time information is transmitted to the target network node in at least one of: a Handover Preparation message, an initial Handover Preparation message, a HANDOVER REQUEST xNAP message, a HANDOVER REQUIRED MESSAGE, a HANDOVER REQUEST NGAP message.

Example Embodiment C6. The method of any one of Example Embodiments C1 to C5, further comprising transmitting the time information to the wireless device.

Example Embodiment C7. The method of Example Embodiment C6, wherein the time information comprises a plurality of time windows, and wherein each of the plurality of time windows is associated with a respective one of a plurality of target cells.

Example Embodiment C8. The method of Example Embodiment C7, wherein the plurality of target cells comprises at least two cells associated with the target network node.

Example Embodiment C9. The method of any one of Example Embodiments C1 to C8, wherein the time information or another message transmitted to the target network node indicates that the target network node can release at least one resource reserved for the wireless device when the time window expires.

Example Embodiment C10. The method of any one of Example Embodiments C1 to C9, further comprising receiving from the target network node an indication that the wireless device has been successfully accessed the target cell and/or completed the handover to the target network node.

Example Embodiment C11. The method of Example Embodiment C10, further comprising: determine that at least one other target network node received the time information associated with the handover of the wireless device; and based on the at least one other target node having received the time information, determine not to transmit to at least one other target network node, a handover cancel message.

Example Embodiment C12. The method of Example Embodiment C10, further comprising: determine that at least one other target network node received the time information associated with the handover of the wireless device; determine whether a remaining time left before an expiration of the time window is greater than a minimum threshold; and based on the remaining time left before the expiration of the time window being greater than a minimum threshold, determining to transmit, to the at least one other target network node, a handover cancel message to trigger a release of at least one resource reserved for handover of the wireless device by the at least one other target network node.

Example Embodiment C13. The method of Example Embodiment C10, further comprising: determine that at least one other target network node received a serving time information for a source cell associated with the source network node; based on the at least one other target node having received the serving time information for the source cell, determine not to transmit to at least one other target network node, a handover cancel message.

Example Embodiment C14. The method of Example Embodiment C10, further comprising: determine that at least one other target network node received a serving time information for a source cell associated with the source network node; determine whether a remaining time left before an expiration of the serving time information is greater than a minimum threshold; and based on the remaining time left before the expiration of the serving time information being greater than a minimum threshold, determining to transmit, to the at least one other target network node, a handover cancel message to trigger a release of at least one resource reserved for handover of the wireless device by the at least one other target network node.

Example Embodiment C15. The method of any one of Example Embodiments C1 to C14, wherein the network node comprises a gNodeB (gNB).

Example Embodiment C16. The method of any of the previous Example Embodiments, further comprising: obtaining user data; and forwarding the user data to a host or a user equipment.

Example Embodiment C17. A network node comprising processing circuitry configured to perform any of the methods of Example Embodiments C1 to C16.

Example Embodiment C18. A computer program comprising instructions which when executed on a computer perform any of the methods of Example Embodiments C1 to C16.

Example Embodiment C19. A computer program product comprising computer program, the computer program comprising instructions which when executed on a computer perform any of the methods of Example Embodiments C1 to C16.

Example Embodiment C20. A non-transitory computer readable medium storing instructions which when executed by a computer perform any of the methods of Example Embodiments C1 to C16.

### Group D Example Embodiments

Example Embodiment D1. A method by a target network node during handover of a wireless device in a Non-Terrestrial Network from a source network node, the method comprising: receiving time information from the source network node, the time information indicating at least one time window for performing, by the wireless device, the handover to at least one target cell associated with the target network node.

Example Embodiment D2. The method of Example Embodiment D1, wherein the handover comprises as conditional handover (CHO).

Example Embodiment D3. The method of any one of Example Embodiments D1 to D2, wherein the time window comprises at least one of: a start time, an end time, a time window duration, and/or a serving cell stop time.

Example Embodiment D4. The method of any one of Example Embodiments D1 to D3, wherein the time information is received from the source network node in a handover configuration.

Example Embodiment D5. The method of any one of Example Embodiments D1 to D4, wherein the time information is received from the source network node in at least one of: a Handover Preparation message, an initial Handover Preparation message, a HANDOVER REQUEST xNAP message, a HANDOVER REQUIRED MESSAGE, a HANDOVER REQUEST NGAP message.

Example Embodiment D6. The method of any one of Example Embodiments D1 to D5, wherein the time information comprises a plurality of time windows, and wherein each of the plurality of time windows is associated with a respective one of a plurality of target cells.

Example Embodiment D7. The method of Example Embodiment D6, wherein the plurality of target cells comprises at least two cells associated with the target network node.

Example Embodiment D8. The method of any one of Example Embodiments D1 to D7, wherein the time information or another message received from the source network node indicates that the target network node can release at least one resource reserved for the wireless device when the time window expires.

Example Embodiment D9. The method of any one of Example Embodiments D1 to D8, further comprising, before expiration of the time window, transmitting to the source network node an indication that the wireless device has been successfully accessed the target cell and/or completed the handover to the target network node.

Example Embodiment D10. The method of any one of Example Embodiments D1 to D8, further comprising, after an expiration of the time window, transmitting to the source network node an indication that the handover of the wireless device to the target network node has failed.

Example Embodiment D11. The method of any one of Example Embodiments D1 to D10, further comprising: based on the at least one time window, reserving at least one resource for the handover of the wireless device to the target cell.

Example Embodiment D12. The method of Example Embodiment D11, further comprising: determining that the at least one time window has expired and releasing the at least one resource that was reserved for the handover of the wireless device to the target cell.

Example Embodiment D13. The method of Example Embodiment D11, further comprising: determining that the at least one time window has expired and determining that at least a margin of time has passed after the at least one time window has expired; based on the at least one time window expiring and the margin of time passing after the expiration of the at least one time window, releasing the at least one resource that was reserved for the handover of the wireless device to the target cell.

Example Embodiment D14. The method of Example Embodiment D1 to D13, further comprising determining, based on the time information and/or the at least one time window, a latest time that the UE can execute the handover to the target cell.

Example Embodiment D15. The method of Example Embodiment D14, further comprising determining that the latest time that the UE can execute the handover to the target cell has passed and releasing at least one resource reserved for the handover of the wireless device to the target cell.

Example Embodiment D16. The method of any one of Example Embodiments D1 to D15, further comprising taking at least one action based on at least one of the time information and/or the at least one time window, wherein the at least one action includes at least one of: determining a latest time that the wireless device can successfully execute the handover to the target cell associated with the target network node; determining a period of time to reserve at least one resource for the handover of the wireless device to the target cell; and determining a time to release at least one resource reserved for the handover of the wireless device to the target cell.

Example Embodiment D17. The method of Example Embodiment D1 to D165, further comprising determining, based on the time information and/or the at least one time window, a serving cell stop time associated with a time that the source network node will stop serving the wireless device in a serving cell; and taking at least one action based on the serving cell stop time.

Example Embodiment D18. The method of Example Embodiment D17, wherein the at least one action includes at least one of: determining a latest time that the wireless device can successfully execute the handover to the target cell associated with the target network node; determining a period of time to reserve at least one resource for the handover of the wireless device to the target cell; and determining a time to release at least one resource reserved for the handover of the wireless device to the target cell.

Example Embodiment D19. The method of any one of Example Embodiments D1 to D18, wherein the network node comprises a gNodeB (gNB).

Example Embodiment D20. The method of any of the previous Example Embodiments, further comprising: obtaining user data; and forwarding the user data to a host or a user equipment.

Example Embodiment D21. A network node comprising processing circuitry configured to perform any of the methods of Example Embodiments D1 to D20.

Example Embodiment D22. A computer program comprising instructions which when executed on a computer perform any of the methods of Example Embodiments D1 to D20.

Example Embodiment D23. A computer program product comprising computer program, the computer program comprising instructions which when executed on a computer perform any of the methods of Example Embodiments D1 to D20.

Example Embodiment D24. A non-transitory computer readable medium storing instructions which when executed by a computer perform any of the methods of Example Embodiments D1 to D20.

### Group E Example Embodiments

Example Embodiment E1. A user equipment for time-based handover in Non-Terrestrial Networks, comprising: processing circuitry configured to perform any of the steps of any of the Group A Example Embodiments; and power supply circuitry configured to supply power to the processing circuitry.

Example Embodiment E2. A network node for time-based handover in Non-Terrestrial Networks, the network node comprising: processing circuitry configured to perform any of the steps of any of the Group B, C, and D Example Embodiments; power supply circuitry configured to supply power to the processing circuitry.

Example Embodiment E3. A user equipment (UE) for time-based handover in Non-Terrestrial Networks, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B, C, and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B, C, and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B, C, and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B, C, and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B, C, and D Example Embodiments to receive the user data from the UE for the host.

Example Embodiment E27. The method of the previous Example Embodiment, further comprising at the network node, transmitting the received user data to the host.

1. A method by a source network node for handover of a wireless device in a Non-Terrestrial Network to a target network node, the method comprising:
transmitting, to the target network node, time information for performing, by the wireless device, the handover to a target cell associated with the target network node.

2. The method of claim 1, wherein the time information comprises at least one of:
a start time of a time window,
an end time of a time window,
a time window duration, and
a serving cell stop time.

3. The method of claim 1, wherein the handover comprises a conditional handover, CHO.

4.-5. (canceled)

6. The method of claim 1, wherein the time information is transmitted to the target network node in at least one of: a handover configuration, a Handover Preparation message, an initial Handover Preparation message, a X2AP HANDOVER REQUEST message, a XnAP HANDOVER REQUEST message, a NGAP HANDOVER REQUIRED message, a NGAP HANDOVER REQUEST message, a S1AP HANDOVER REQUIRED message, and a S1AP HANDOVER REQUEST message.

7. The method of claim 1 wherein the time information or another message transmitted to the target network node indicates that the target network node can release at least one resource reserved for the wireless device at an expiration of a time window duration.

8. The method of claim 1, comprising:
based on the target network node having received the time information, determining not to transmit a handover cancel message to at least one other target network node.

9. The method of claim 1 comprising:
determining that at least one other target network node received the time information associated with the handover of the wireless device;
determining whether a remaining time left before an expiration of a time duration window is greater than a minimum threshold; and
based on the remaining time left before the expiration of the time window duration being greater than a minimum threshold, determining to transmit, to the at least one other target network node, a handover cancel message to trigger a release of at least one resource reserved for handover of the wireless device by the at least one other target network node.

10. The method of claim 1, comprising:
determining that at least one other target network node received a serving cell stop time for a source cell associated with the source network node;
based on the at least one other target network node having received the serving cell stop time for the source cell, determining not to transmit a handover cancel message to the at least one other target network node.

11. The method of claim 1, comprising:
determining that at least one other target network node received a serving cell stop time for a source cell associated with the source network node;
determining whether a remaining time left before an expiration of the serving cell stop time is greater than a minimum threshold; and
based on the remaining time left before the expiration of the serving cell stop time being greater than a minimum threshold, determining to transmit, to the at least one other target network node, a handover cancel message to trigger a release of at least one resource reserved for handover of the wireless device by the at least one other target network node.

12. A method by a target network node during handover of a wireless device in a Non-Terrestrial Network from a source network node to the target network node, the method comprising:
receiving, from the source network node, time information for performing, by the wireless device, the handover to a target cell associated with the target network node.

13.-23. (canceled)

24. A source network node for handover of a wireless device in a Non-Terrestrial Network to a target network node, the source network node comprising processing circuitry configured to:
transmit, to the target network node, time information for performing, by the wireless device, the handover to a target cell associated with the target network node.

25. The source network node of claim 24, wherein the time information comprises at least one of:
a start time of a time window,
an end time of a time window,
a time window duration, and
a serving cell stop time.

26. The source network node of claim 24, wherein the handover comprises a conditional handover, CHO.

27.-28. (canceled)

29. The source network node of claim 24, wherein the time information is transmitted to the target network node in at least one of: a handover configuration, a Handover Preparation message, an initial Handover Preparation message, a X2AP HANDOVER REQUEST message, a XnAP HANDOVER REQUEST message, a NGAP HANDOVER REQUIRED message, a NGAP HANDOVER REQUEST message, a S1AP HANDOVER REQUIRED message, and a S1AP HANDOVER REQUEST message.

30. The source network node of claim 24, wherein the time information or another message transmitted to the target network node indicates that the target network node can release at least one resource reserved for the wireless device at an expiration of a time window duration.

31. The source network node of claim 24, wherein the processing circuitry is configured to:
based on the target network node having received the time information, determine not to transmit a handover cancel message to at least one other target network node.

32. The source network node of claim 24, wherein the processing circuitry is configured to:
determine that at least one other target network node received the time information associated with the handover of the wireless device;
determine whether a remaining time left before an expiration of a time duration window is greater than a minimum threshold; and
based on the remaining time left before the expiration of the time window duration being greater than a minimum threshold, determine to transmit, to the at least one other target network node, a handover cancel message to trigger a release of at least one resource reserved for handover of the wireless device by the at least one other target network node.

33. The source network node of claim 24, wherein the processing circuitry is configured to:
determine that at least one other target network node received a serving cell stop time for a source cell associated with the source network node;
based on the at least one other target network node having received the serving cell stop time for the source cell, determine not to transmit a handover cancel message to the at least one other target network node.

34. The source network node of claim 24, wherein the processing circuitry is configured to:
determine that at least one other target network node received a serving cell stop time for a source cell associated with the source network node;
determine whether a remaining time left before an expiration of the serving cell stop time is greater than a minimum threshold; and
based on the remaining time left before the expiration of the serving cell stop time being greater than a minimum threshold, determine to transmit, to the at least one other target network node, a handover cancel message to trigger a release of at least one resource reserved for handover of the wireless device by the at least one other target network node.

35. A target network node during handover of a wireless device in a Non-Terrestrial Network from a source network node to the target network node, the target network node comprising processing circuitry-configured to:
receive, from the source network node, time information for performing, by the wireless device, the handover to a target cell associated with the target network node.

36.-46. (canceled)
